(19) United States
(12) Patent Application Publication
(10) Pub. No.: US 2007/0023459 A1
(43) Pub. Date: Feb. 1, 2007

(54) Liquid dispensing apparatus

(76) Inventors: Jeff Harder, Harris Courty, TX (US); Roderick W. Styron, Liberty County, TX (US); Glen Hahn, Harris County, TX (US); Byron Davis, Chambers County, TX (US); Keith Trzecki, Harris County, TX (US)

Correspondence Address: Steven D. Boyd;Arkema Inc., 2000 Market Street, Philadelphia, PA, 19103, US

(21) Appl. No.: 11/191,531

(22) Filed: Jul. 28, 2005

(51) Int. Cl. B67D 5/60

(52) U.S. Cl. 222/464.1

(57) ABSTRACT

The present invention relates to an apparatus to transfer liquid from an industrial, rigid liquid package. The apparatus of the present invention is a hollow tube in a U configuration. One leg of the U is inserted into the bung or hole in the top of a rigid liquid package. The section of the apparatus that is inserted into the liquid package is shapes so as to ensure that fluid from the container can enter the hollow apparatus. The apparatus is removably affixed to a rigid liquid package. The apparatus includes a counter-weight which inhibits tipping of the container as it is emptied as well as a configuration which facilitates the removal of substantially all liquid for the rigid liquid package via a fluid pump connected to the apparatus.

### FIELD OF THE INVENTION

The present invention relates to liquid dispensing apparatus and more particularly to an apparatus which facilitated the transfer of liquid from a container, typically a container smaller than a 55 gallon drum.

### BACKGROUND OF THE INVENTION

Transportation and handling of liquids in industrial settings can be either in large, bulk containers such as tank trucks, rail cars or totes, or in smaller drums or containers. Containers smaller than the ubiquitous 55 gallon drum are routinely used to transport, store and dispense industrial liquids. Representative smaller containers include those available from sources such as North American Packaging Corporation of Raleigh, N.C. Such rigid industrial packages are available in a variety of sizes and shapes. Sizes for such containers typically range from 2 to 20 gallons. These smaller containers are typically emptied by being lifted and the liquid poured out through a hole or bung in the top of the container.

This method of emptying such smaller containers can result in spills or splashing that are undesirable and potentially hazardous.

### SUMMARY OF THE INVENTION

The present invention relates to an apparatus for dispensing liquids from smaller containers. The apparatus allows the transfer of liquid from smaller containers with minimal spilling or splashing. As used herein, smaller containers refers to rigid industrial packaging for liquid transportation, storage and handling. While the present invention will be described with respect to use on containers of from 2 to 20 gallons, the apparatus could be easily adapted for use in larger containers such as drums or totes. The apparatus of the present invention is configured to be inserted in and removably affixed to a rigid liquid package. The apparatus includes a counter-weight which inhibits tipping of the container as it is emptied as well as a configuration which facilitates the removal of substantially all of the liquid from the container.

### BRIEF DESCRIPTION OF THE DRAWINGS

FIG. 1 is a plan view of the liquid transfer apparatus in accordance with the present invention.

### DETAILED DESCRIPTION OF THE INVENTION

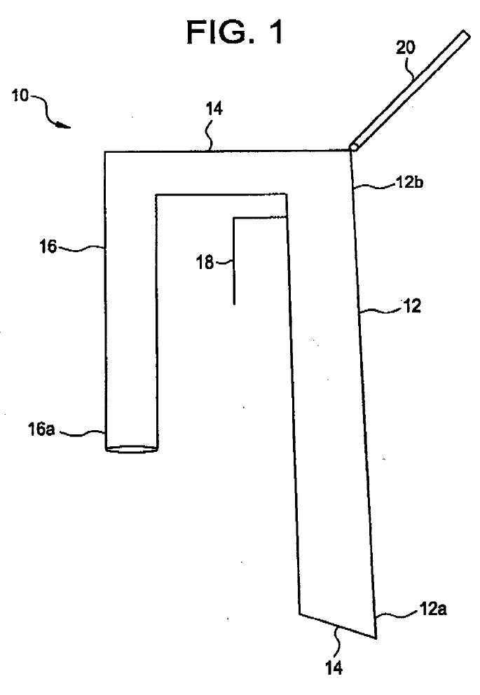

The apparatus 10 of the present invention comprises a generally “U” shaped apparatus which is hollow. The cross-sectional shape of the apparatus is typically circular, forming a tube. However, hollow cross-sectional shapes other than circular are within the scope of the present invention. The apparatus of the present invention can be formed of any suitable material including but not limited to stainless steel, polymers etc. The first leg 12 of the U shape is of a length and outside diameter such as to allow it to be inserted into a bung or similar hole in the top of a liquid container (not shown). The first leg 12 is of a length so as to extend to the bottom of the liquid container. The terminal or lower end 12a of the first leg 12 is open, as at 14, to allow liquid in the container to enter the hollow apparatus. The terminal or lower end 12a of the first leg 12 includes means to ensure that it cannot sealingly engage the bottom of the container. The shape of terminal end 12a can comprise an angle as shown in FIG. 1. Alternatively, the shape of terminal end 12a can compries spacing extensions or holes in the lower end 12a of first leg 12. The spacing means on the terminal end 12a of first leg 12 ensure that if first leg 12 contacts the bottom of the liquid container, a seal does not form. If such a seal were to form, it could prevent liquid from entering the apparatus. This allows the apparatus to extend to the very bottom of the liquid container so that substantially all of the liquid can be removed while preventing the apparatus from sealing to the bottom of the liquid container.

Extending from the upper end 12b of first leg 12 is hollow second section 14 which forms the base of the U shape. The second section 14 extends from the first leg 12 so as to form, at some point, a right angle. The second leg 14 can be formed from a substantially straight hollow section as shown in FIG. 1 or may comprise a curved hollow member. The second section 14 is of a length such that it will extend to the outer edge of the liquid container when the first leg 12 is inserted into the bung or opening in a liquid container.

Extending from the second section 14, at substantially a right angle and generally parallel to and in the same direction as first leg 12 is third section 16. Third section 16 is of such a length so as to extend downward adjacent an outer vertical surface of the liquid container when first leg 12 is inserted in to the bung or hole in the liquid container. The lower end 16a of the third section 16 includes means, not shown, for attaching a hose or pipe to remove liquid from the liquid container. The attachment means can comprise, threads, internal or external, a swage lock fitting, a breach lock fitting or any other suitable attachment means. The apparatus can thereby be removably attached to a liquid feed pump, not shown, through a flexible or rigid hose.

Extending from the apparatus 10 in close proximity to the transition from the first leg 12 to the second section 14 is a counter-weight 20. The counter-weight 20 extends in a direction generally opposite that of the second section 14. The counter-weight 20 is of sufficient weight to inhibit tipping of the liquid container as fluid is withdrawn. The weight of the apparatus and the attached hose concentrated at the periphery of the upper portion of the liquid containers can result in the container tipping as the liquid level drops. The counter-weight 20 prevents this. The counter-weight 20 can be permanently affixed to the apparatus, or preferably removably affixed such as by threads or any other suitable means. The counter-weight 20 is preferably in the shape of a handle to facilitate use of the apparatus.

Optionally oriented on the first leg 12 adjacent the transition to the second section 14 is a clip 18 or other suitable fixation means to engage the top and/or side of the liquid container. The clip 18 or other fixation means can engage the top, side or top and side of the liquid container when the first leg 12 is inserted in to the hole or bung. The clip 18 or other fixation means removably locks the apparatus in position on the liquid container during use. The fixation means can comprises a clip as shown, a threaded fitting to engage a bung on the container, a clip extended from third section 16 or any other suitable fixation means including the size and shape of the apparatus itself.

While the present invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

What is claimed is:

1. An apparatus for facilitating liquid removal from a container having an opening in the top of the container comprising
a substantially U shaped, hollow apparatus having first section having a diameter to fit through the opening in the top of the container and of such a length to extend substantially to the bottom of the container;
a lower end of said first section including means to allow liquid flow into said section when in contact with a bottom surface of said container;
a second section extending from an upper end of said first section at substantially a right angle and of a length so as to extend to an outer edge of said container;
a third section extending from said second section at substantially a right angle, substantially parallel and in the same direction as said first section thereby forming a U shape;
counter-weight means mounted on said apparatus, adjacent the transition from said first section to said second section extending in a direction opposite said second section; and
means to connect said third section to a pump to withdraw liquid from said container through said apparatus.

2. The apparatus of claim 1 wherein said counter-weight means is rigidly affixed to said apparatus.

3. The apparatus of claim 1 wherein said counter-weight means is removably attached to said apparatus.

4. The apparatus of claim 1 further including fixation means to removably fix said apparatus on said container.

5. The apparatus of claim 4 wherein said fixation means comprises a clip extending form said first section.
